(19) United States
(12) Patent Application Publication
(10) Pub. No.: US 2014/0307077 A1
(43) Pub. Date: Oct. 16, 2014

(54) APPARATUSES AND METHODS FOR IRIS IMAGING

(71) Applicant: DELTA ID INC., Fremont, CA (US)

(72) Inventor: SALIL PRABHAKAR, Fremont, CA (US)

(73) Assignee: Delta ID Inc., Fremont, CA (US)

(21) Appl. No.: 13/860,134

(22) Filed: Apr. 10, 2013

(51) Int. Cl. G06K 9/00

(52) U.S. Cl. CPC G06K 9/00604
USPC 348/78

(57) ABSTRACT

The invention includes a method and apparatus for acquiring an image of a subject's iris, within the near infrared region of the electromagnetic spectrum. Near infrared radiation is generated from an incandescent light source, having wavelengths spread across 700 nm to 900 nm. The iris is illuminated for imaging by directing the generated near infrared radiation along an optical path between the incandescent light source and an intersection of a field of view region and depth of field region of an iris camera. Near infrared radiation scattered by the iris and transmitted along the iris camera's optical axis is received at the iris camera. An image of the iris is then acquired at the iris camera, based on radiation scattered by the iris and received at the iris camera.

### FIELD OF INVENTION

The invention relates to an imaging apparatus, for obtaining images of one or more features of a subject's eye for biometric identification. The invention is particularly operable to obtain images of a subject's iris for iris recognition.

### BACKGROUND

Methods for biometric identification based on facial features, including features of the eye are known. Methods for iris recognition implement pattern-recognition techniques to compare an acquired image of a subject's iris against a previously stored image of the subject's iris, and thereby determine or verify identity of the subject. A digital template corresponding to an acquired iris image is encoded based on the image, using mathematical/statistical algorithms. The digital template is thereafter compared against databases of previously encoded digital templates (corresponding to previously acquired iris images), for locating a match and thereby determining or verifying identity of the subject.

Apparatuses for iris recognition typically comprise an imaging apparatus for capturing an image of the subject's iris(es) and an image processing apparatus for comparing the captured image against previously stored iris image information. The imaging apparatus and image processing apparatus may comprise separate devices, or may be combined within a single device.

It has been found that apparatuses for image capture perform better when images of the iris are acquired in the near infrared region of the electromagnetic spectrum i.e. using wavelengths falling between 700 nanometres (nm) and 900 nm for image capture. The near infrared spectrum has been found to perform better against a range of iris pigmentations, and is capable of revealing iris texture not easily observed in the visible region of the electromagnetic spectrum. Additionally, it has been found that illuminating irises with multiple wavelengths within the near infrared region of the spectrum is useful to address pigmentation related variations in absorption of wavelengths.

Based on the above, best practices recommended by standard setting bodies include a requirement that the imaging apparatus must be capable of capturing radiation in the range of 700 nm to 900 nm (i.e. the near infrared spectrum). Best practices further recommend providing a spectral spread for illumination of the iris (i.e. illumination covering a range of wavelengths within the near infrared region of the electromagnetic spectrum).

With a view to properly illuminate the iris for image acquisition within the recommended spectral spread, prior art imaging apparatuses accordingly utilize one or more infrared LEDs capable of generating infrared wavelengths within the 700 nm to 900 nm range. With a view to provide a spectral spread across the 700 nm to 900 nm range, prior art devices typically use multiple infrared LEDs, each configured to generate infrared wavelengths covering a portion of the desired spectral spread. Recent advances in LED technologies have additionally made it possible to combine multiple LEDs into a single package (multi-wavelength infrared LED) and thus capable of generating a spectral spread across the entire 700 nm to 900 nm range.

A consequence of existing solutions for providing illumination in the near infrared region, is the high cost of infrared LEDs—which can cause costs of manufacture of imaging apparatuses to increase. The increase in cost is yet more significant for imaging apparatuses seeking to provide an illumination spread covering a range (or multiple ranges) of wavelengths within the near infrared region (e.g. across the entire 700 nm to 900 nm region). In such cases, the imaging apparatus typically requires multiple infrared LEDs, each generating infrared wavelengths covering a portion of the desired spectral spread, or a multi-wavelength infrared LED. It would be understood that the costs of incorporating either of these solutions significantly adds to the cost of manufacture.

A second set of problems commonly associated with iris recognition systems are those arising in connection with ambient light i.e. light from a source other than the intended source of iris illumination. Typical examples of ambient light are sunlight, or light sources external to but in the vicinity of the imaging apparatus.

Ambient light can interfere with iris recognition systems in several ways. Strong ambient light causes subjects to squint—thereby occluding the iris, and preventing capture of images of the entire iris.

Ambient light also gives rise to specular reflections which are captured by the imaging apparatus, and which interfere with pattern recognition. Prior art imaging apparatuses reduce specular reflections by using optical filters (band pass filters/long pass filters) designed to allow only a select set of wavelengths to pass through, and to attenuate (either by absorption or reflection or interference) undesired wavelengths. By selecting a band pass filter designed to transmit only those wavelengths generated by the illumination source of the imaging apparatus, prior art devices seek to significantly reduce the intensity of specular reflections caused by ambient light. In prior art devices using wavelengths within the near infrared region for iris illumination, filters are selected to reflect or absorb visible wavelengths, while transmitting infrared wavelengths. A commonly used filter for such devices is a cold mirror—which is a specialized filter that reflects the entire visible light spectrum while efficiently transmitting infrared wavelengths.

Yet further, ambient light can cause difficulties for image capture despite introduction of filters for attenuating visible wavelengths. Since, such filters transmit infrared radiation, they allow passage of the infrared component of ambient light to, which infrared component thereafter interferes with image formation by infrared waves from the illumination source. To ameliorate interference by the infrared component of ambient light, intensity of infrared radiations from the illumination source is required to be increased in comparison to the intensity of the infrared component of ambient light. Increasing intensity of infrared radiation incident on a subject's iris can however cause discomfort and may also damage the iris.

Specular reflections caused by ambient light may alternatively be ameliorated with strobed illumination and shuttered cameras.

It would however be understood that all of the above solutions for addressing problems caused by ambient light, such as use of filters, strobed illumination and shuttered cameras increase the complexity, size and cost of the imaging apparatus. Additionally, even with the use of filters, prior art devices often require to increase intensity of infrared radiation generated at the illumination source, which can be harmful for the subject.

In addition to the above, it has been found that (i) positioning of the subject's eye and (ii) orientation of the subject's iris, relative to the imaging apparatus has consequences for image acquisition and for optimizing encoding and subsequent matching of digital templates of iris images.

### SUMMARY OF THE INVENTION

The present invention includes a method for acquiring an image of a subject's iris, within the near infrared region of the electromagnetic spectrum. In an embodiment, near infrared radiation is generated from an incandescent light source, having wavelengths spread across 700 nm to 900 nm. The iris is illuminated for imaging by directing the generated near infrared radiation along an optical path between the incandescent light source and an intersection of a field of view region and depth of field region of an iris camera. Near infrared radiation scattered by the iris and transmitted along the iris camera's optical axis is received at the iris camera. An image of the iris is then acquired at the iris camera, based on radiation scattered by the iris and received at the iris camera.

The iris may be simultaneously illuminated by directing visible wavelengths and near infrared wavelengths generated from the incandescent light source along the optical path.

In an embodiment, the image acquired at the iris camera is based on simultaneously received visible wavelengths and near infrared radiation scattered by the iris and transmitted along the iris camera's optical axis.

The method may additionally include optimizing area of the iris available for image capture by directing visible light generated by the incandescent light source along the optical path and on to the iris, thereby causing the subject's pupil to constrict.

In a particular embodiment of the method, the incandescent light source may be a single incandescent element.

The method may further include providing a light shield disposed to block ambient light from being reflected off the iris.

In an embodiment, the step of providing the light shield may comprise resiliently deforming at least a portion of the light shield against corresponding portions of the subject's facial anatomy to create a light tight seal around the subject's eye.

The method may also include positioning a feedback object such that, the feedback object is fully visible only when the subject's iris is located within the intersection of the field of view region and the depth of field region of the iris camera.

In a specific embodiment of the method, the incandescent light source is also the feedback object. In another embodiment, the incandescent light source is positioned to illuminate the iris and the feedback object.

The method may also include disposing an occluder between the incandescent light source and intersection of the field of view region and the depth of field region, wherein the occluder prevents the subject from partially or fully viewing the feedback object from at least one position outside the intersection of the field of view region and the depth of field region. In an embodiment, the occluder includes an aperture.

In another embodiment of the method, the feedback object is positioned such that in viewing the feedback object, the subject's eye is looking in the direction of the iris camera. In certain embodiments, the feedback object may be positioned such that in viewing the feedback object, deviation between a direction in which the subject's eye is looking and a direction at which the iris camera is located relative to the eye, is between 0° and 30°.

In a particular embodiment of the invention, the incandescent light source generates near infrared wavelengths having an intensity sufficient for iris image acquisition and visible wavelengths having an intensity insufficient to cause the subject to squint.

The intensity of visible wavelengths may be either chosen or regulated to a degree sufficient to allow the subject to widen its eyelid to fully observe the incandescent light source. The intensity of visible wavelengths may additionally be either chosen or regulated to a degree sufficient to constrict the iris or the subject's eye.

The invention additionally includes an apparatus for acquiring an image of a subject's iris within the near infrared region of the electromagnetic spectrum. The apparatus includes an incandescent light source, an iris camera and a housing. In an embodiment, the incandescent light source of the apparatus generates near infrared radiation having wavelengths spread across 700 nm to 900 nm, and is positioned to illuminate the iris with the near infrared radiation. The iris camera may be enabled to acquire images within the near infrared region of the electromagnetic spectrum, and positioned to receive near infrared radiation transmitted from the incandescent light source and scattered by the iris.

The incandescent light source additionally generates visible light and may be positioned to illuminate the iris with visible light and near infrared radiation.

The iris camera may be configured to acquire images based on visible light and near infrared radiation and in an embodiment, is positioned to simultaneously receive visible light and near infrared radiation transmitted from the incandescent light source and scattered by the iris.

The incandescent light source may additionally be positioned to optimize area of the iris available for image capture by directing visible light onto the iris, thereby causing the subject's pupil to constrict.

In a specific embodiment of the apparatus, the incandescent light source is a single incandescent element.

The apparatus housing may comprise a light shield to block ambient light from causing specular reflections on the iris.

The light shield may conform to corresponding portions of facial anatomy to provide a light tight seal around the subject's eye.

In a particular embodiment of the apparatus, a feedback object may be positioned such that in viewing said feedback object, the subject's iris is located within an intersection of a field of view region and a depth of field region of the iris camera.

In a yet more specific embodiment, the incandescent light source is itself the feedback object.

The incandescent light source may be positioned to illuminate both the iris and the feedback object.

The apparatus may additionally include an occluder disposed between the incandescent light source and the intersection of the field of view region and the depth of field region. In an embodiment, the occluder prevents the subject from partially or fully viewing the feedback object from at least one position outside the intersection of the field of view region and the depth of field region.

In a particular embodiment of the apparatus, the occluder is provided with an aperture.

The feedback object may be positioned such that in viewing the feedback object, the subject's eye is looking in the direction of the iris camera. In certain embodiments, the feedback object may be positioned such that in viewing the feedback object, deviation between a direction in which the subject's eye is looking and a direction at which the iris camera is located relative to the eye, is between 0° and 30°.

In one embodiment, the incandescent light source generates near infrared wavelengths having an intensity sufficient for iris image acquisition and visible wavelengths having an intensity insufficient to cause the subject to squint.

The incandescent light source of the apparatus may generate visible wavelengths having intensity of a sufficiently low degree so as to cause the subject to widen its eyelid to fully observe the intensity regulated incandescent light source.

### BRIEF DESCRIPTION OF THE ACCOMPANYING DRAWINGS

FIG. 1 illustrates considerations for correct positioning of the subject's eye for image capture.

FIG. 1A is a functional block diagram of an apparatus for iris recognition.

FIG. 2 illustrates an imaging apparatus according to the present invention.

FIG. 2A illustrates an imaging apparatus including a feedback object.

FIGS. 2B and 2C illustrate an embodiment of an occluder.

FIG. 3 illustrates a transverse section of an embodiment of the imaging apparatus.

FIGS. 4A to 4G respectively show right, front, left, top, rear, bottom and perspective views of an embodiment of the imaging apparatus.

FIGS. 5A and 5B illustrate perspective and top views of another embodiment of the imaging apparatus.

FIGS. 6A and 6B illustrate exemplary optical elements for altering an optical path between objects.

### DETAILED DESCRIPTION

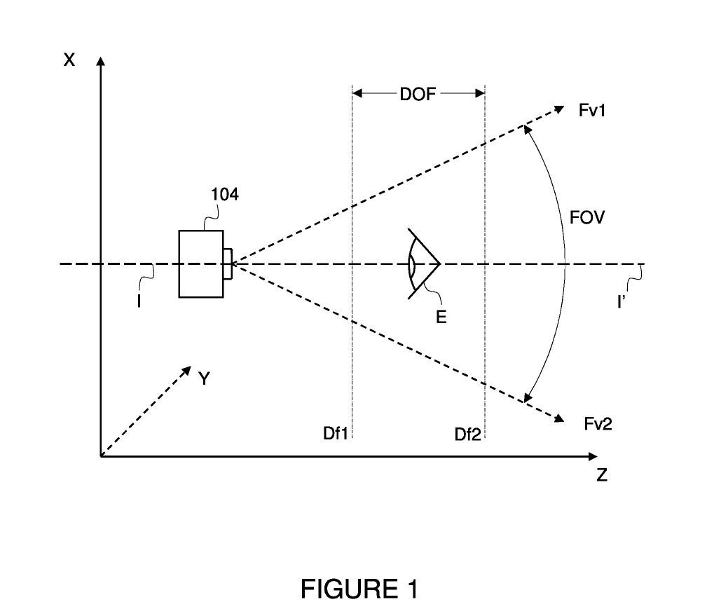

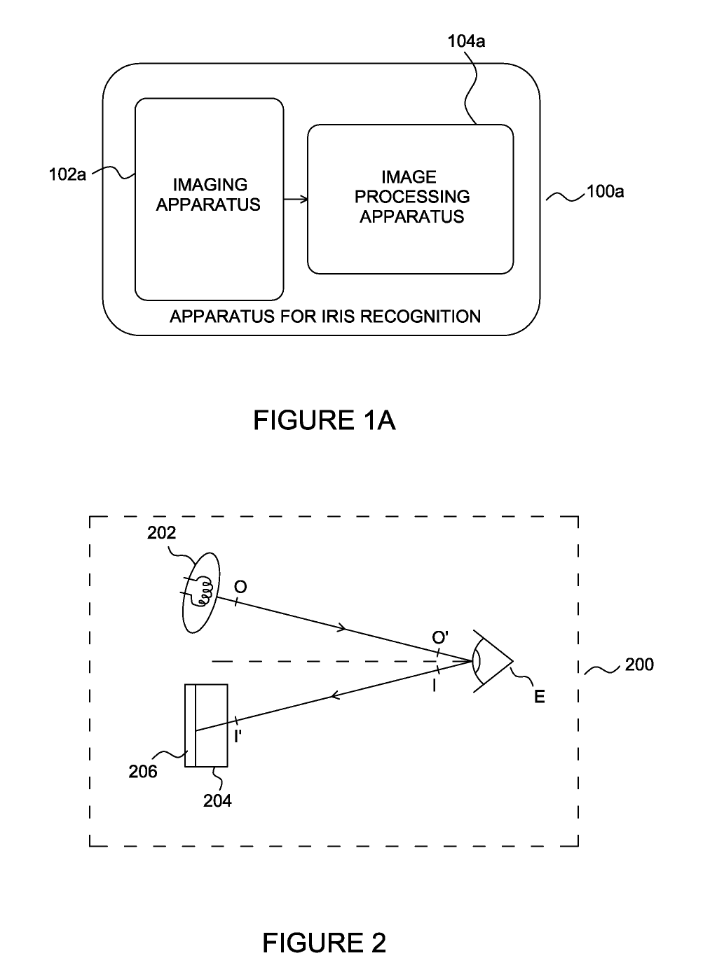

FIG. 1 illustrates some considerations for correct positioning of the subject's eye for image capture. As illustrated in FIG. 1, iris imaging camera 104 has a finite and fixed field of view FOV (i.e. the volume of inspection capable of being captured on the camera's image sensor). In FIG. 1, field of view FOV is the region defined by dashed lines Fv1 and Fv2. Iris imaging camera 104 additionally has a depth of field DOF—wherein depth of field DOF defines the region within which a subject's iris would appear acceptably sharp and in sufficient detail for the purposes of iris image capture. In FIG. 1, depth of field DOF is the region between dashed lines Df1 and Df2, along the z axis.

For image acquisition, subject's eye E is required to be positioned within the volume defined by the intersection of the field of view FOV and the depth of field DOF—which ensures that the acquired iris image has sufficient sharpness and detail. Portions of subject's eye E that remain outside the field of view FOV region would not be acquired by iris imaging camera 104. Similarly, if subject's eye E is positioned outside the depth of field DOF region, the acquired image may be unfocussed (if outside the depth of field DOF region) and may additionally have insufficient iris texture detail (if outside the depth of field DOF region in the direction away from the iris imaging camera 104).

In addition to positioning the subject's eye correctly within the intersection of the field of view FOV and depth of field DOF), it is also preferable to ensure appropriate orientation of the subject's iris with respect to optical axis I-I′ of iris imaging camera 104, to ensure that portions of the iris are not distorted or occluded during image acquisition. For example, if the subject's gaze is directed peripherally, the iris moves towards the sides of the eye socket opening, which results in image acquisition of only a portion of the iris and/or a distorted view of the iris. For optimal iris image acquisition, the iris should be positioned substantially towards the centre of the eye socket opening and substantially centred along the optical axis I-I′ of iris imaging camera 104 for image acquisition.

It is known that the objectives of (i) positioning of a subject's eye and (ii) ensuring optimal orientation of the iris relative to the optical axis of the iris imaging camera, may be addressed by providing a feedback object on which the subject is required to direct its gaze for image acquisition. The feedback object may be positioned so that, in directing its gaze towards the feedback object for viewing, the subject's eye assumes a correct position within the intersection of the iris imaging camera's field of view and depth of field. The feedback object is additionally positioned in a manner that, directing a subject's gaze towards the feedback object ensures optimal positioning of the iris within the eye socket opening and also along the optical axis of the camera.

The feedback object may be any visible object, and is configured and located to ensure appropriate positioning of the eye and also the iris for image acquisition. Examples of feedback objects include numerals, characters, text, illustrations, images or sources of illumination. The feedback object may be illuminated by ambient light for viewing, or alternatively may be illuminated by one or more light sources within the imaging apparatus.

FIG. 1A is a functional block diagram of an apparatus for iris recognition 100a, comprising an imaging apparatus 102a and an image processing apparatus 104a. Imaging apparatus 102a acquires an image of the subject's iris and transmits the image to image processing apparatus 104a. The image captured by imaging apparatus 102a may be a still image or a video image. Image processing apparatus 104a thereafter analyses and compares data extracted from the captured image of the subject's iris against data extracted from previously acquired iris images, to identify the subject, or to verify the identify of the subject.

Although not illustrated in FIG. 1A, it would be understood that apparatus for iris recognition 100a may include other components, including for extracting still frames from video images, for processing and digitizing image data, and for enabling communication between components of the apparatus. The imaging apparatus, image processing apparatus and other components of an apparatus for iris recognition may each comprise separate devices, or may be combined within a single device.

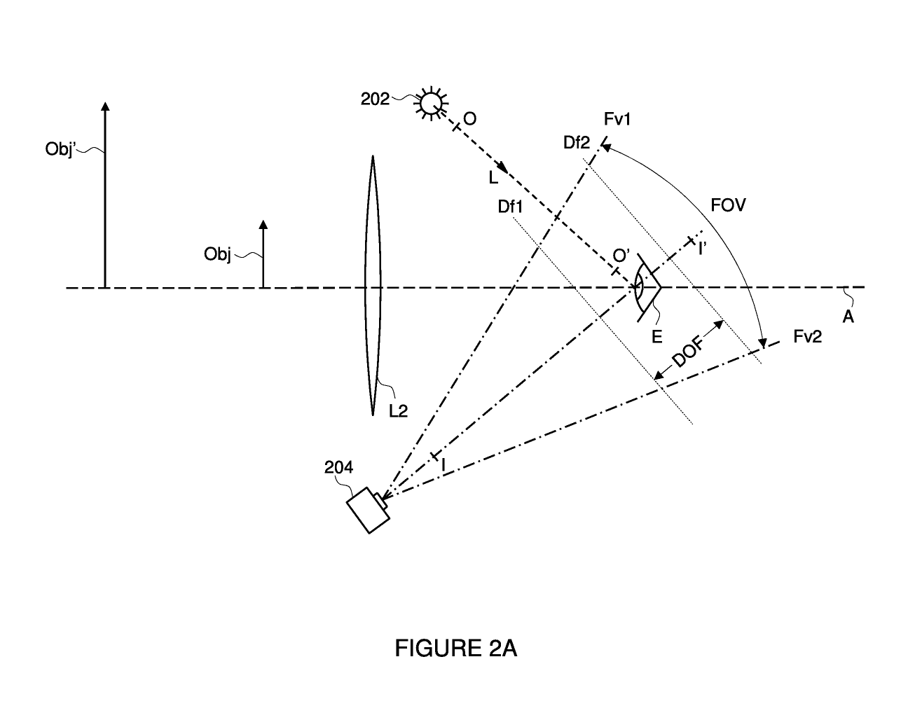

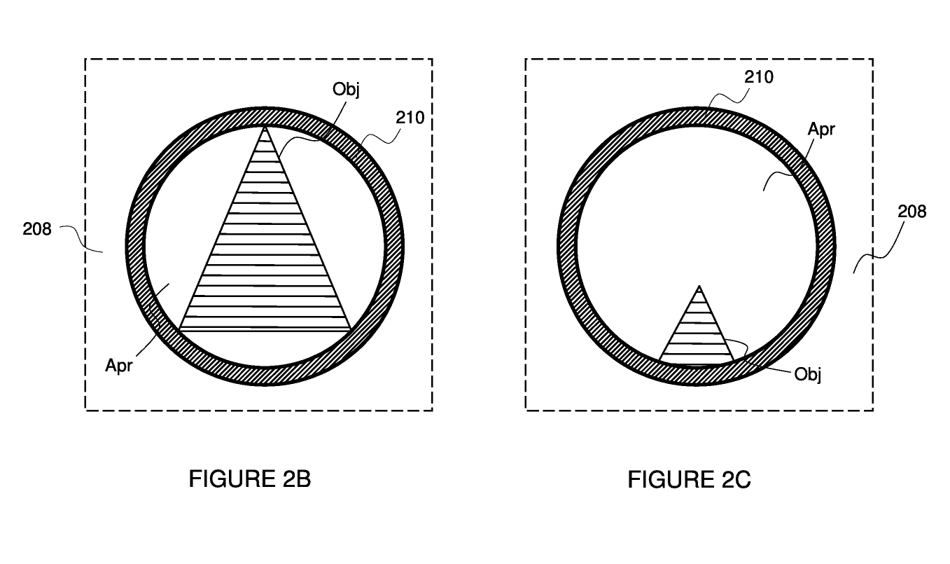

FIG. 2 illustrates an imaging apparatus 200 according to the present invention, for capturing an image of the subject's iris(es).

Imaging apparatus 200 comprises an illumination source 202 and an iris imaging camera 204. In the present invention illumination source 202 is selected so that in operation, illumination source 202 generates infrared radiation with wavelengths within the near infrared region of the electromagnetic spectrum and particularly within the 700 nm to 900 nm region. Iris imaging camera 204 is correspondingly configured to capture images within the near infrared region of the electromagnetic spectrum.

As shown in FIG. 2, radiation generated by illumination source 202 travels towards the subject's eye E along optical path O-O′ and is thereafter scattered by (reflected off) the eye E towards iris imaging camera 204 along optical axis I-I′ of the iris imaging camera. Iris imaging camera 204 receives the radiation scattered from the eye E and accordingly acquires an image of subject's eye E.

In an embodiment, illumination source 202 comprises at least one incandescent light. In operation, incandescent light sources generate radiation in the visible region as well as in the infrared region (and particularly in the near infrared region) of the electromagnetic spectrum. The incandescent light as illumination source 202 is configured to generate radiation including the desired 700 nm to 900 nm wavelength radiation for illumination and image capture of the subject's iris.

For the purposes of the disclosure, “incandescence” (and variations thereof) shall be understood to refer to the emission of electromagnetic radiation (including visible wavelengths) from a hot body as a result of its temperature. The terms “incandescent light”, “incandescent lamp”, “incandescent bulb”, “incandescent light source”, “incandescent lamp” and “incandescent element”, shall be understood to refer to a light source which produces radiation from a filament (or other material) heated to a high temperature by passing an electric current through it.

Since incandescent light sources generate radiation across the entire wavelength spread considered desirable for iris recognition (including wavelengths in the near infrared region, across 700 nm to 900 nm), use of an incandescent light source for illumination source 202 achieves the objective of appropriate spectrum spread within the near infrared region while simultaneously avoiding reliance on multiple LEDs each generating infrared radiation within a portion of the desired spectrum spread.

In an embodiment, since the incandescent light source simultaneously generates radiation across the near infrared spectrum and the visible spectrum, radiation scattered from subject's eye E includes radiation in both the visible spectrum and across the 700 nm to 900 nm region of the near infrared spectrum. The combination of visible and near infrared wavelengths to illuminate eye E enables iris imaging camera 204 to acquire more information regarding iris texture and across a wider spectrum of subject populations, than would be possible by use of only one of visible or near infrared wavelengths.

Additionally, owing to ubiquity of incandescent lights as an article of manufacture, a significant saving in costs can be achieved over the use of infrared LEDs. The cost benefit is particularly significant by avoiding having to rely upon multiple infrared LEDs or multiple wavelength infrared LEDs that would otherwise be necessary for generating the desired spectrum spread over 700 nm to 900 nm wavelengths. Further, in the embodiment where the invention simultaneously uses visible and infrared radiation for iris illumination and image capture, use of a single incandescent light source for generating both types of illumination leads to efficiencies of cost and space, and also reduces complexity of the imaging apparatus.

In an embodiment of the invention iris imaging camera 204 may comprise an image sensor 206 capable of converting an optical image into an electronic signal. In a preferred embodiment, image sensor 206 may comprise a charge-coupled device (CCD) or a complementary metal oxide semiconductor (CMOS). It would be understood that both CCD and CMOS image sensors are capable of image capture within the infrared (including near infrared) region of the electromagnetic spectrum and simultaneously in the visible region of the electromagnetic spectrum.

While not illustrated in FIG. 2, in certain embodiments of the invention, iris imaging camera 204 may additionally comprise one or more optical lenses designed to converge radiation scattered from the subject's eye onto image sensor 206.

In an embodiment of the invention, imaging apparatus 200 may also include a visible light source to optimize the area of an iris available for image capture—by directing visible light onto the iris with the objective of causing the pupil to constrict, and thereby increasing the area of the iris available for imaging.

The incandescent light source in any of the above described embodiments of the invention may consist of a single incandescent element. In a specific embodiment, the visible light and near infrared radiation used to illuminate the iris for image capture are both generated from a single incandescent element. In another embodiment, the near infrared radiation for illuminating the iris for image capture, and the visible light for optimizing area of the iris available for imaging, are both generated from a single incandescent element. In yet another embodiment the visible light and near infrared radiation used to illuminate the iris for image capture, and also the visible light for optimizing area of the iris available for imaging, are all generated from a single incandescent element.

In operation, generation of near infrared radiation and visible radiation from a single incandescent element, for the purposes of scattering from an iris and onto an image sensor, considerably simplifies construction of the imaging apparatus.

In an embodiment of the invention, the imaging apparatus may include a feedback object. The feedback object may be any object visible to the eye, and disposed to ensure appropriate positioning of the eye and orientation of the iris itself. Without limitation, appropriate feedback objects may include written matter such as text, numerals or characters, illustrations or images, sources of illumination such as an incandescent light or light emitting diode (LED) or any visible two or three dimensional object. The feedback object may be illuminated by ambient light for viewing, or may be illuminated by a dedicated light source, or may be illuminated by light sources from the imaging apparatus itself.

The embodiment illustrated in FIG. 2A comprises iris imaging camera 204, lens element L2, and feedback object Obj, wherein Obj and L2 are positioned such that the subject would see an image (Obj′) of object Obj when eye E is within the field of view region FOV. In directing the subject's gaze towards lens element L2 to observe object Obj, the subject's iris assumes an orientation appropriate for optimal image acquisition by iris imaging camera 204 i.e. where the iris is substantially centred along optical axis I-I′ of iris imaging camera 204. While the illustrated embodiment interposes lens element L2 between eye E and feedback object Obj, in other embodiments, lens element L2 may be omitted altogether, in which case the subject would see object Obj when eye E is within the field of view region FOV.

In an embodiment of the invention, the feedback object may be the same incandescent light source 202 that is provided for generating near infrared radiation having wavelengths spread across 700 nm to 900 nm, and that is positioned to illuminate the iris with the near infrared radiation. In another embodiment of the invention, the feedback object may be illuminated by the incandescent light source 202, which is simultaneously positioned to illuminate the iris with near infrared radiation for image acquisition. As evident from the disclosure below, the embodiment involving illumination of the feedback object by incandescent light source 202 is of particular relevance when the apparatus includes a light shield for blocking ambient light.

In the embodiments described in the immediately preceding paragraph, incandescent light source 202 is required to be positioned within the imaging apparatus such that, in viewing incandescent light source 202 or in viewing the feedback object illuminated by incandescent light source 202, subject's eye E is required to be positioned within the volume defined by the intersection of the field of view FOV and the depth of field DOF of the iris imaging camera 204.

In an embodiment of the invention incorporating a feedback object for positioning a subject's eye, an occluder may be incorporated within the apparatus to provide the subject with visual feedback regarding correct positioning.

The occluder contemplated by the invention may include an opaque, translucent or non-transparent element disposed between the feedback object and potential viewing positions of the eye (such as the intersection of the field of view region and depth of field region), to partially or fully occlude the feedback object when the eye is not in an optimal position for image capture. The occluder may include a mask (or other opaque or substantially non-transparent element) having an aperture or window provided therein. Non-limiting examples of an occluder involve an annular structure, a slit, pipe, tube, cylinder, keyhole or other structure, having a window or aperture within a substantially non-transparent element such that the window or aperture of the occluder wholly, substantially or partially surrounds the feedback object and allows an unobstructed view of the feedback object from at least one viewing position.

FIGS. 2B and 2C illustrate an embodiment of the occluder, wherein occluder 208 has an annular window 210 defining aperture Apr. FIG. 2B illustrates the entire feedback object Obj (a triangle in the illustrated embodiment), as would be visible when the subject's eye is positioned entirely within the field of view FoV region of the iris camera. FIG. 2C illustrates the feedback image Obj as partially visible when the subject's eye is positioned outside the field of view FoV region of the iris camera. It will be understood that the desired function of occluder 208 may be achieved by positioning the occluder such that it obstructs the passage of radiation scattered off feedback object Obj to positions outside the field of view FoV of the iris imaging camera. The aperture Apr is configured and positioned so as to permit passage of radiation scattered off feedback object Obj to positions within the field of view FoV of the iris imaging camera.

In an embodiment of the invention incorporating the feedback object, an optical system (such as a lens element) is disposed between the subject's eye and the feedback object to project a virtual image of the object in front of the subject's eye. In a more particular implementation an occluder of the kind discussed in the immediately preceding paragraph may be incorporated to provide the user with visual feedback regarding correct positioning of the eye. The occluder is configured and located such that it partially occludes the virtual image of the feedback object unless the eye is in an optimal position for image capture.

In an embodiment, incandescent light source 202 is positioned to also ensure that in directing its gaze towards said incandescent light source 202 or towards the feedback object illuminated by incandescent light source 202, the subject's eye is looking in the direction of iris imaging camera 204. In certain embodiments, incandescent light source 202 may be positioned such that in viewing incandescent light source 202, the deviation between a direction in which the subject's eye is looking and a direction at which the iris camera is located relative to the eye, is between 0° and 30°.

In one embodiment, the incandescent light source 202 (or the incandescent light source 202 and feedback object Obj) may be positioned or configured such that in directing its gaze on said incandescent light source (or on the feedback object illuminated by the incandescent light source), a subject's eyes are caused to instinctively open wider, thereby reducing occlusion of the iris by the eyelid and eyelashes and optimizing the visible surface area of the iris for image capture. In an embodiment, light source 202 is located above iris imaging camera 204.

While the desired configuration and/or positioning may be achieved in a plurality of alternative ways, in a specific embodiment, incandescent light source 202 is chosen or regulated to generate (i) near infrared wavelengths having an intensity sufficient for iris image acquisition, and (ii) visible wavelengths having an intensity insufficient to cause the subject to squint.

In a specific embodiment, the incandescent light source is chosen or regulated to generate visible wavelengths having intensity of a sufficiently low degree so as to allow the subject to widen its eyelid to fully observe the intensity regulated incandescent light source without discomfort.

In an embodiment, a diffuser (such as a frosted or milky plastic or glass element) may be interposed between incandescent light source 202 and the subject's eye to ensure uniform illumination of the eye. In one embodiment, the diffuser may have a feedback object (such as numerals, characters, text, illustrations, or images) provided thereon.

In a preferred embodiment of imaging apparatus 200, a single incandescent light source 202 (i) generates near infrared radiation for illumination of the iris for image capture, (ii) generates visible radiation for illumination of the iris for image capture (iii) generates and directs visible radiation onto the iris for causing the pupil to constrict and thereby increasing the area of the iris available for imaging and (iv) optimizes area of the iris available for imaging by causing the subject's eye to open wider.

The invention additionally provides a light shield to block ambient light from being scattered by the subject's eye and travelling to the iris imaging camera. By blocking ambient light, the light shield reduces problems arising from specular reflections caused by ambient light.

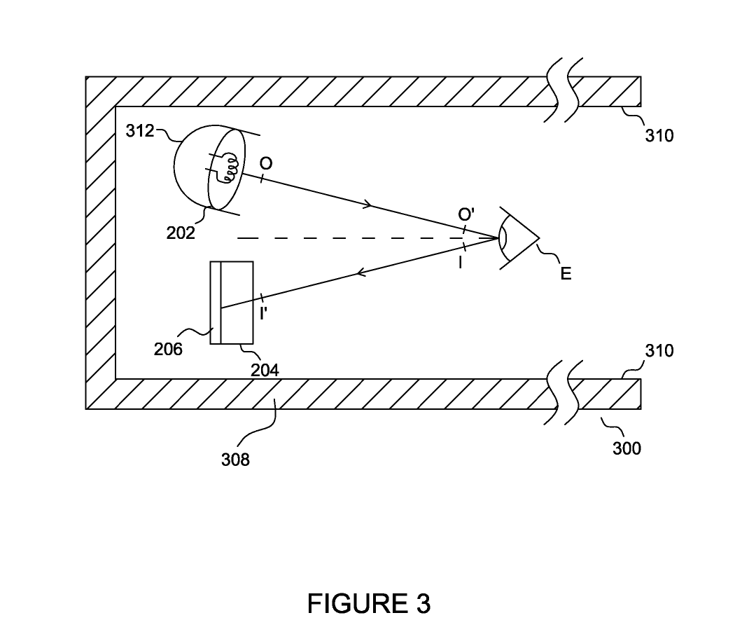

FIG. 3 illustrates a transverse section of imaging apparatus 300. In the illustrated embodiment, imaging apparatus 300 includes housing 308, which encases illumination source 202 and iris imaging camera 204. In addition to encasing and protecting components of imaging apparatus 300, housing 308 is structured so that in use, walls 310 surround eye E and prevent ambient light from being scattered or reflected by eye E. In the illustrated embodiment illumination source 202 is housed within a reflector 312, where reflector 312 is positioned to direct radiation generated by illumination source 202 along optical path O-O′ to illuminate the iris of subject's eye E.

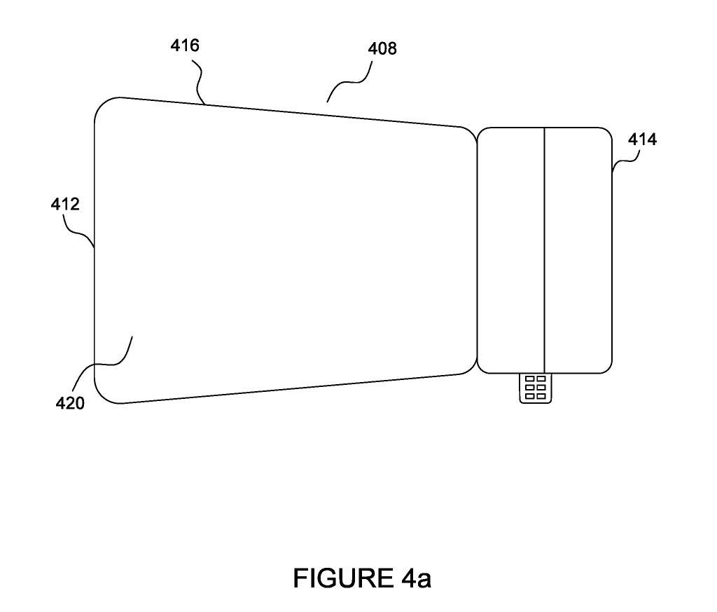

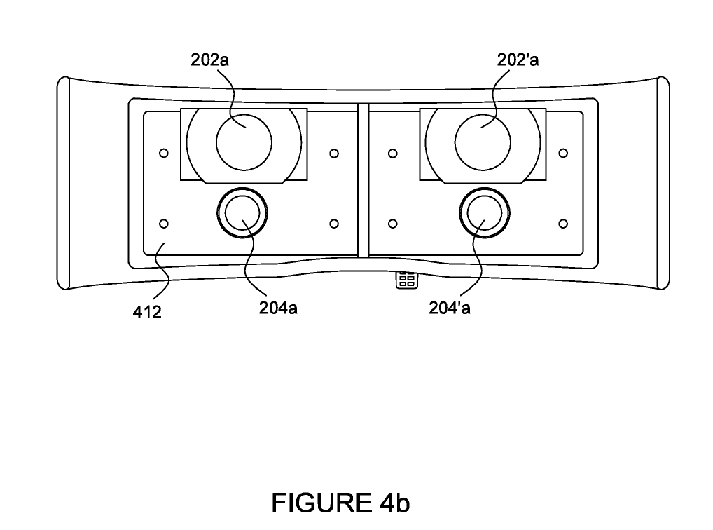

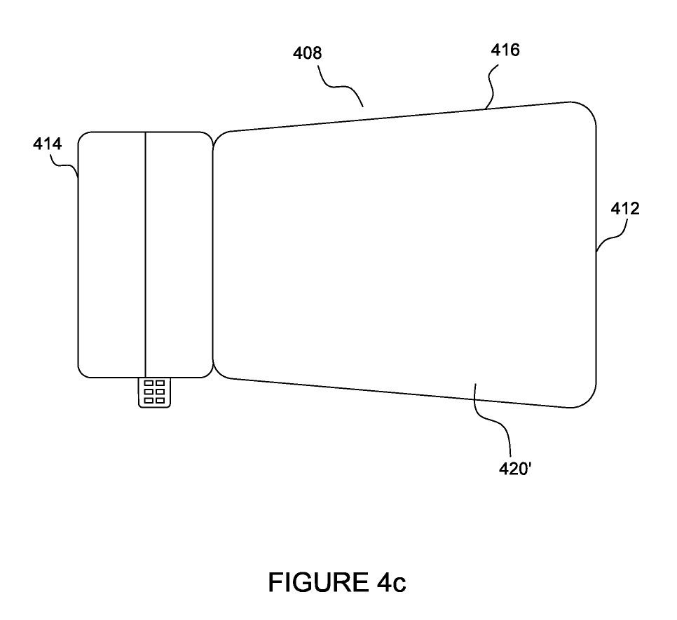

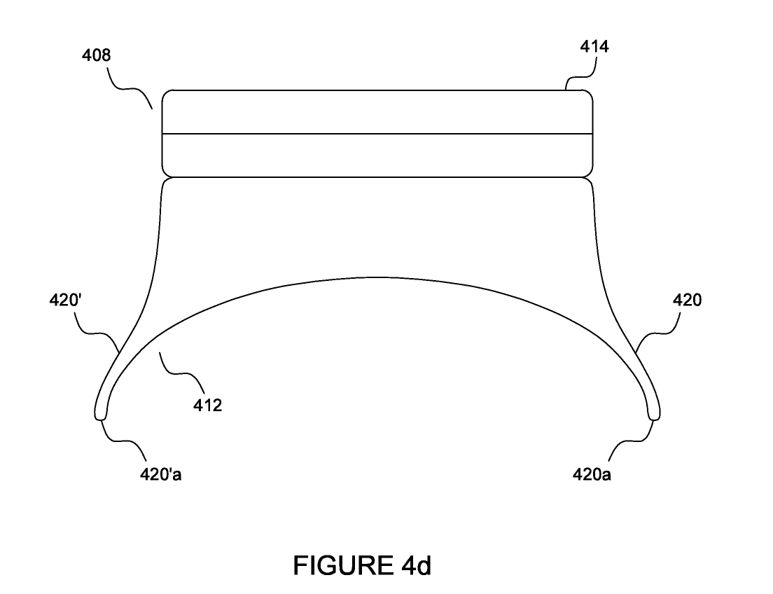

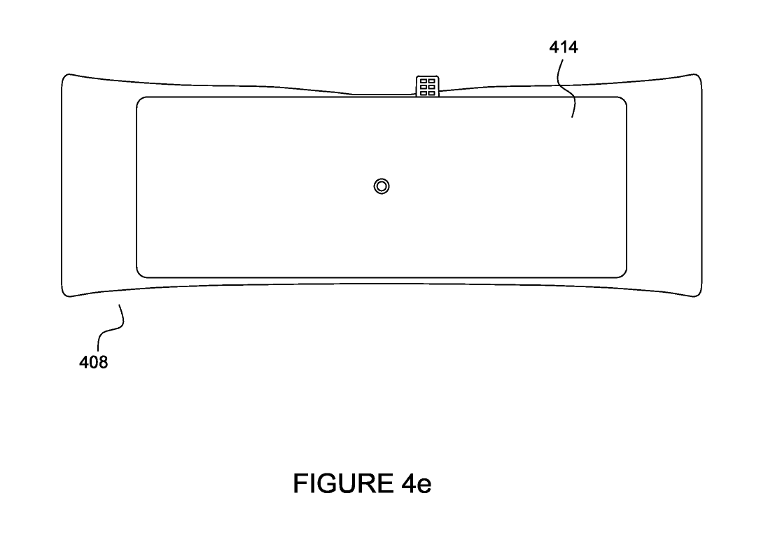

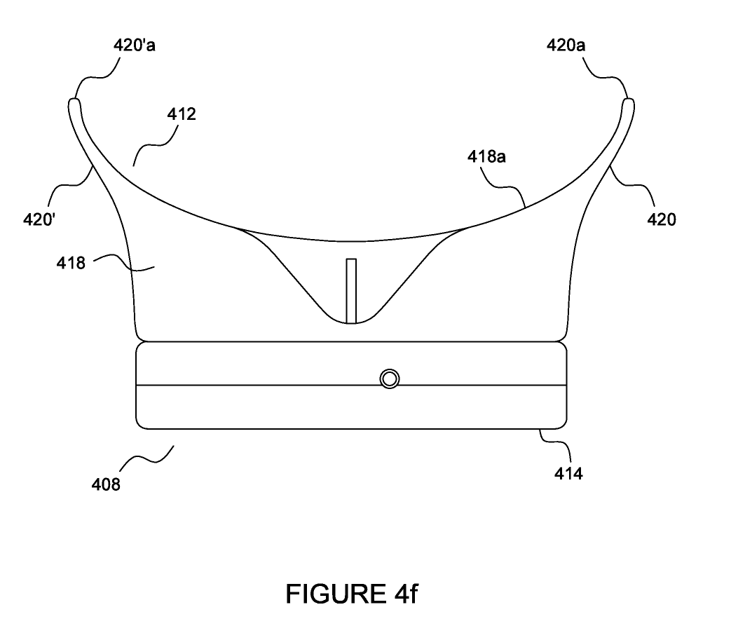

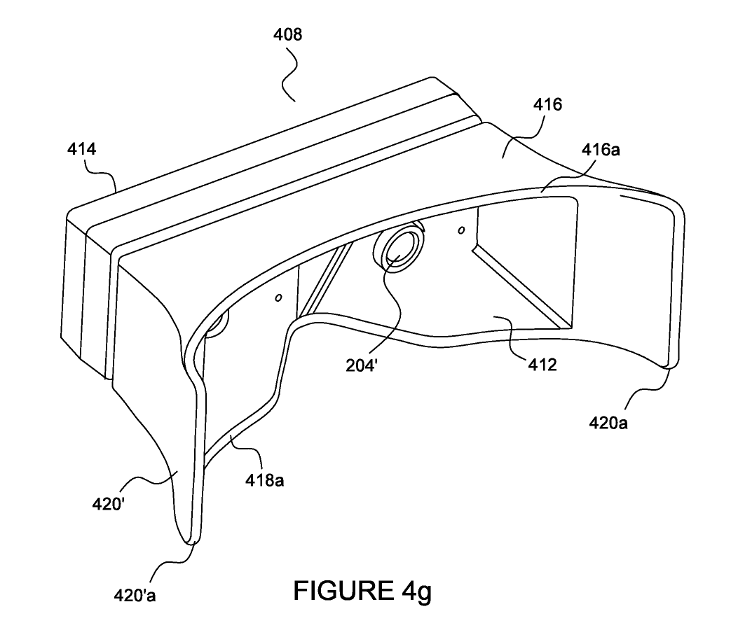

FIGS. 4A to 4G respectively show right, front, left, top, rear, bottom and perspective views of an embodiment of the imaging apparatus, with a view to illustrate configuration of the housing for blocking ambient light. The embodiment illustrated in FIGS. 4A to 4G provides for simultaneous image acquisition of both irises of a subject. In this embodiment housing 408 accordingly encases two illumination sources, visible in FIGS. 4B and 4G only by lenses 202a and 202′a disposed at open end 412 of housing 408, and two corresponding iris imaging cameras, visible in FIGS. 4B and 4G only by camera lenses 204a and 204′a disposed at open end 412 of housing 408, wherein illumination source 202 is paired with iris imaging camera 204 for capturing an image of one iris of a subject, while illumination source 202′ is paired with iris imaging camera 204′ for capturing an image of the subject's second iris.

In the embodiment illustrated in FIGS. 4A to 4G, housing 408 has an open end 412 and a closed end 414. In operating, open end 412 is proximal to the subject's eyes, while closed end 414 is distal to the subject's eye. Open end 412 is configured to enable a subject to position his eyes correctly in relation to the corresponding illumination source (202, 202′) and corresponding iris imaging camera (204, 204′) and at the correct distance to enable iris image capture.

In the embodiment illustrated in FIGS. 4A to 4G, housing 408 is structured such that open end 412 conforms to the anatomy of a human face in the regions that would come in contact with housing 408, when positioned for image capture.

As illustrated in FIGS. 4D and 4G, top surface 416 of housing 408 is provided with proximal end portion 416a, which proximal end portion 416a is configured to approximately conform to and accommodate or rest against a subject's forehead, when in use.

As illustrated in FIGS. 4F and 4G, bottom surface 418 of housing 408 is provided with proximal end portion 418a, which proximal end portion 418a is configured to approximately conform to and accommodate or rest against a subject's nose and cheek bones, when in use.

As illustrated in FIGS. 4D, 4F and 4G, side walls 420 and 420′ of housing 408 are provided with proximal end portions 420a and 420′a respectively, where proximal end portions 420a and 420′a are configured to approximately conform to and accommodate or rest against a subject's temple and surrounding regions of the facial anatomy, when in use. The dimensions of housing 408 may be selected to conform to dimensions of widest face types observed across populations. In an embodiment, the distance between 420a and 420′a may be selected to conform to dimensions of the widest anticipated face type for a population.

Taken together proximal end portions 416a, 418a, 420a and 420′a of housing 408 conform to the anatomy of a subject's face when positioned for image capture, thereby forming a light shield (mask) for blocking ambient light and thereby preventing specular reflections caused by ambient light.

It would be understood that proximal end portions 416a, 418a, 420a and 420′a are shaped to approximately conform to corresponding portions of the facial anatomy. In use, when placed against corresponding portions of the facial anatomy, proximal end portions 416a, 418a, 420a and 420′a may form a light tight seal against the subject's skin and may entirely surround the subject's eyes, thereby preventing ambient light from entering the imaging apparatus. In an embodiment, proximal end portions 416a, 418a, 420a and 420′a may comprise a resiliently deformable material such as rubber or silicone, which provides a comfortable fit against the adjoining facial anatomy and creates a light tight seal with the subject's face. Structuring proximal end portions 416a, 418a and 420a and 420′a to conform to corresponding portions of the facial anatomy additionally assists a subject in positioning the imaging apparatus at an approximately correct position relative to the eyes, for image capture.

Additionally, the imaging apparatus and the relative positions of its illumination source(s), iris imaging camera(s) and housing are configured such that when proximal end portions 416a, 418a, 420a and 420′a are placed against corresponding portions of the facial anatomy, the subject's eyes are at the correct position and focal distance relative to the iris imaging camera, as may be necessary for image capture.

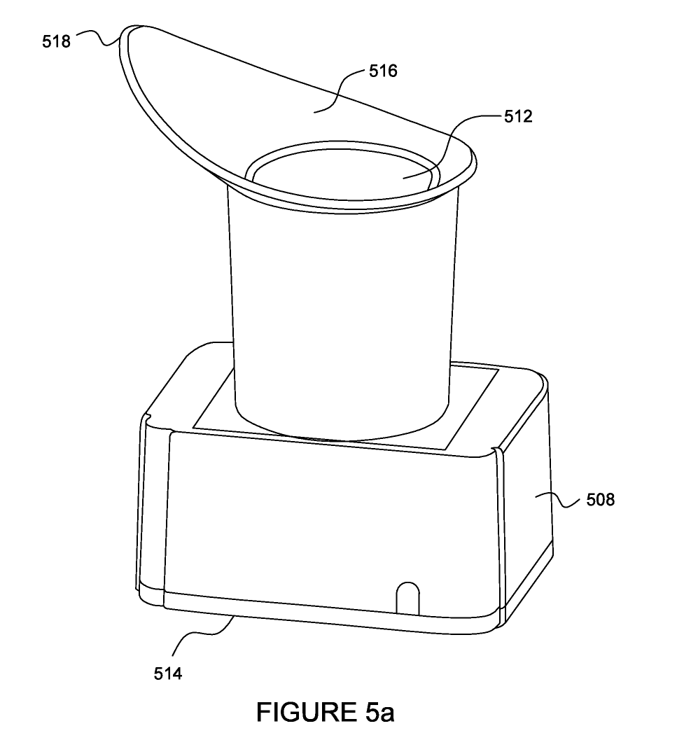

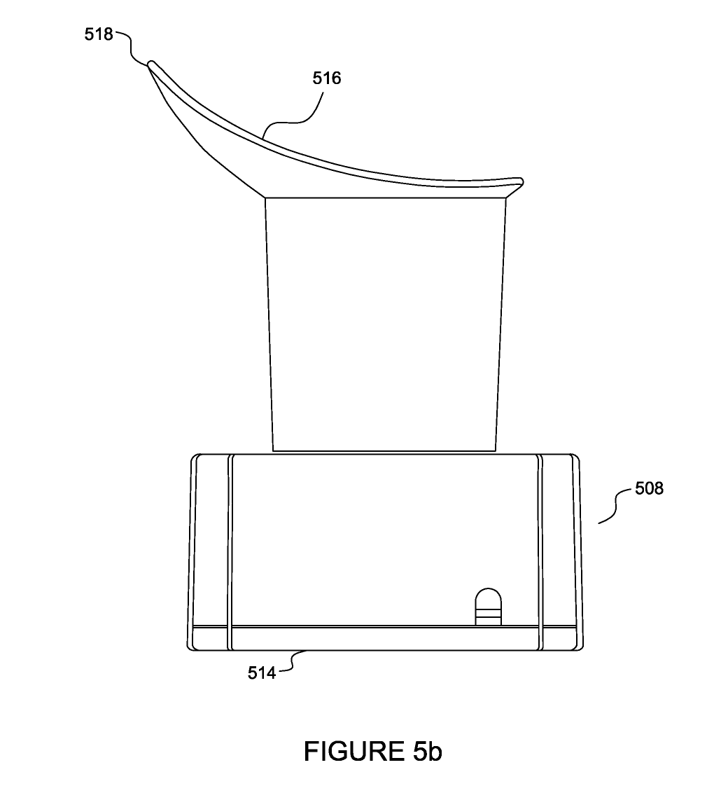

FIGS. 5A and 5B respectively show perspective and top views of another embodiment of the imaging apparatus, with a view to illustrate another configuration of the housing for blocking ambient light. It will be noted that the embodiment illustrated in FIGS. 5A and 5B provides for image capture of one eye of a subject. In this embodiment housing 508 would only encase one illumination source and a corresponding iris imaging camera for capturing an image of one eye of a subject.

Housing 508 has an eyepiece 512 and a closed end 514. In operation, eyepiece 512 is proximal to the subject's eyes, while closed end 514 is distal to the subject's eye. In use, pipe 512 is intended to be placed against the region surrounding a subject's eye for enabling illumination of the iris by the illumination source, and subsequent image capture by the iris imaging camera.

In the embodiment illustrated in FIGS. 5A and 5B, housing 508 is provided with an eyecup 516 fastened to pipe 512. In use, eyecup 516 would be disposed between pipe 512 and the subject's eye, to form a light tight seal entirely around the subject's eye and prevent ambient light from being scattered or reflected by the eye during image capture.

In the embodiment illustrated in FIGS. 5A and 5B, eyecup 516 has a curved configuration to provide a light tight fit around the user's eye socket. Eyecup 516 may additionally be provided with a curving wing 518 to conform to the contours of the facial anatomy in the temple region, thereby providing a stable, comfortable and light tight fit against the subject's eye socket. Eyecup 512 may comprise a resiliently deformable material such as rubber or silicone, which provides a comfortable fit against the adjoining facial anatomy and creates a light tight seal with the subject's face.

Additionally, the imaging apparatus and the relative positions of its illumination source(s), iris imaging camera(s) and housing are configured such that when eyepiece 512 or eyecup 516 are placed against corresponding portions of the facial anatomy, the subject's eye is at the correct position and distance relative to the iris imaging camera, as may be necessary for image capture.

While FIGS. 4A to 5B illustrate specific embodiments of light shields configured to block ambient light, it would be understood that any other structure designed to prevent ambient light from being scattered by the iris and along an optical path between the iris and the iris imaging camera would work equally well for the purposes of the invention.

By preventing ambient light from reaching a subject's eye, the imaging apparatus of the invention does away with the problem of squinting and iris occlusion arising from bright ambient light. Additionally, by blocking ambient light, the imaging apparatus also does away with the requirement for expensive band-pass filters or cold mirrors, or strobed illumination and shutters, that would typically be required to address specular reflections caused by ambient light reflecting off the subject's eye. Yet further, blocking ambient light does away with the necessity for increasing intensity of infrared radiation from the illumination source to ensure that illumination intensity from the illumination source is greater than intensity of the infrared component of ambient light that is transmitted by filters designed to attenuate ambient light. The imaging apparatus of the present invention may accordingly be used in any environment, including outdoors in bright sunlight.

It would be understood that the housing of the present invention, having the light shield for blocking ambient light would work efficiently for any imaging apparatus housing an illumination source and iris imaging camera, regardless of whether the illumination source is an incandescent lamp, infrared LED or other light source.

Equally, it would be understood that the imaging apparatus having an incandescent light source and an iris imaging camera would enable image capture of an iris, with or without the light shielding structures described hereinabove.

The combination of a light shielding structure with an incandescent light source however does present a significant advantage in that, the intensity of light required from the illumination source is much lower in absence of interfering ambient light. Since high intensity incandescent light sources may irritate and damage a subject's vision, combining incandescent illumination with light shielding structures of the present invention can provide yet further advantages in terms of user comfort and safety.

It will be understood that in embodiments of the invention having a light shielding structure, configuring and positioning the incandescent light source as a feedback object, or to illuminate a feedback object offers particular advantages, as a feedback object located within the apparatus would not otherwise be visible in absence of ambient light.

The invention additionally provides a method for acquiring an image of at least one iris of a subject within the 700 nm to 900 nm region of the infrared spectrum.

In the method of the present invention an illumination source comprising an incandescent light source is used to generate near infrared wavelengths spread across the 700 nm to 900 nm region of the infrared spectrum. The near infrared wavelengths so generated are transmitted from the incandescent illumination source to the subject's iris along an optical path between the illumination source and an intersection of the field of view and depth of field regions of the iris camera (where the subject's iris is preferably positioned), and are scattered off the iris to travel along the optical axis of the iris imaging camera. Scattered near infrared wavelengths are received at the iris imaging camera and used to generate an image of the iris in the infrared spectrum.

In another embodiment of the invention, visible wavelengths that are simultaneously generated by the incandescent light source are transmitted from the incandescent illumination source to the subject's iris along the optical path between the illumination source and the subject's iris. The visible wavelengths received at the subject's iris cause the subject's pupil to constrict, thereby maximizing the visible area of the iris for imaging purposes.

In another embodiment of the invention, visible wavelengths that are simultaneously generated by the incandescent light source are also scattered by the iris to travel along the iris imaging camera's optical axis. The iris imaging camera receives both near infrared wavelengths and visible wavelengths scattered by the subject's iris, and acquires an image of the iris based on a spectral spread covering both visible and near infrared wavelengths.

In an embodiment of the invention, the incandescent element itself additionally serves as a feedback object, wherein in viewing the incandescent light element, a subject's iris is required to be positioned within the volume defined by the intersection of the field of view and the depth of field of the iris imaging camera. In another embodiment of the invention, the feedback object may be illuminated by the incandescent light source, which is simultaneously positioned to illuminate the iris with near infrared radiation for image acquisition. The incandescent element (or feedback object illuminated by the incandescent element) may additionally be positioned such that when positioned for viewing said incandescent element (or said illuminated feedback object), the subject's iris is located within the intersection of the field of view FoV and depth of focus DoF of the iris imaging camera. In certain embodiments, the incandescent element (or feedback object illuminated by the incandescent element may be positioned such that when positioned for viewing said incandescent element (or said illuminated feedback object) either (i) the subject's eye is looking in the direction of the iris camera; or (ii) the deviation between a direction in which the subject's eye is looking and a direction at which the iris camera is located relative to the eye, is between 0° and 30°.

In an embodiment of the method involving providing a feedback object for positioning a subject's eye, an occluder may be disposed within the apparatus to provide the subject with visual feedback regarding correct positioning. In an embodiment, the occluder may be selected from among opaque, translucent or non-transparent structures disposed between the feedback object and potential viewing positions of the eye, to partially occluder the feedback object unless the eye is in an optimal position for image capture. Non-limiting examples of the occluder may include a mask, ring, slit, pipe, tube, cylinder, keyhole or other structure having a central aperture that wholly, substantially or partially surrounds the feedback object and allows an unobstructed view of the feedback object from at least one viewing position.

In an embodiment of the invention incorporating a feedback object, an optical system (such as a lens element) may additionally be disposed between the subject's eye and the feedback object to project a virtual image of the object in front of the subject's eye. In a specific implementation an occluder of the kind discussed in the immediately preceding paragraph may be incorporated to provide the user with visual feedback regarding correct positioning of the eye. The occluder may be selected and positioned such that it partially occludes the virtual image of the feedback object unless the eye is in an optimal position for image capture i.e. within the intersection of the field of view FoV and depth of field DoF of the iris imaging camera.

In one embodiment of the method of the present invention, the intensity of radiations emitted by the incandescent element may be chosen or regulated to generate near infrared wavelengths having an intensity sufficient for iris image acquisition and visible wavelengths having an intensity insufficient to cause the subject to squint (or otherwise occlude the iris by partly closing the eyelid).

In a more specific embodiment, the intensity of radiations emitted by the incandescent element is chosen such that the intensity of emitted radiation (i) is sufficient for the purpose of image acquisition by the iris imaging camera, and (ii) is sufficiently low so as to allow the subject to widen its eyelid to fully observe the incandescent light source with comfort, and (iii) is bright enough to sufficiently constrict the iris.

In another embodiment of the invention, the near infrared radiations for enabling image acquisition, the visible radiations for enabling image acquisition, and the visible radiations for constricting the subject's pupil, and the visible radiations for illuminating a feedback object are all generated from a single light source, comprising a single incandescent element.

In an embodiment of the method, the light source and iris imaging camera are positioned correctly relative to the subject's iris by placing against the subject's facial anatomy, a housing within which the light source and iris imaging camera are positioned.

In another embodiment of the invention, a light tight seal is disposed around the subject's eye, thereby preventing ambient light from being scattered by the subject's iris. In an embodiment, the light tight seal is provided by placing the housing against corresponding portions of the subject's facial anatomy.

It would be understood that while the method of the present invention can be implemented using the imaging apparatus described hereinabove, such other apparatuses capable of implementing are equally contemplated by the invention.

In the embodiments illustrated in FIGS. 1, 2, 2A and 3, radiation shown travelling from the illumination source to the subject's eye, and from the subject's eye to the iris imaging camera in linear paths. In alternate embodiments however, the paths need not be linear—and optical elements including mirrors, prisms, or pentaprisms may be used to redirect radiation between any two objects within the contemplated apparatuses along non-linear paths.

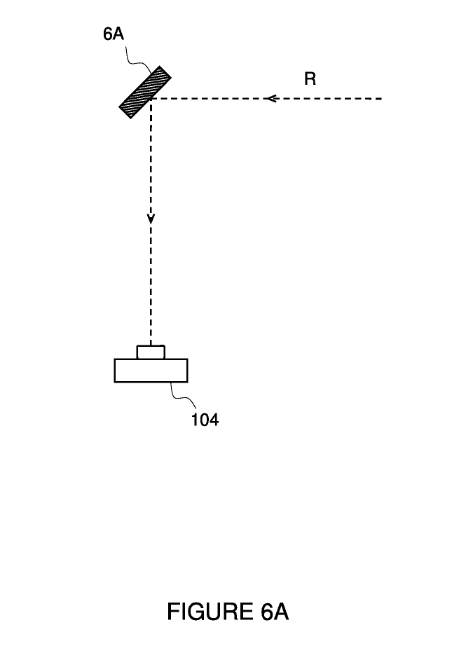

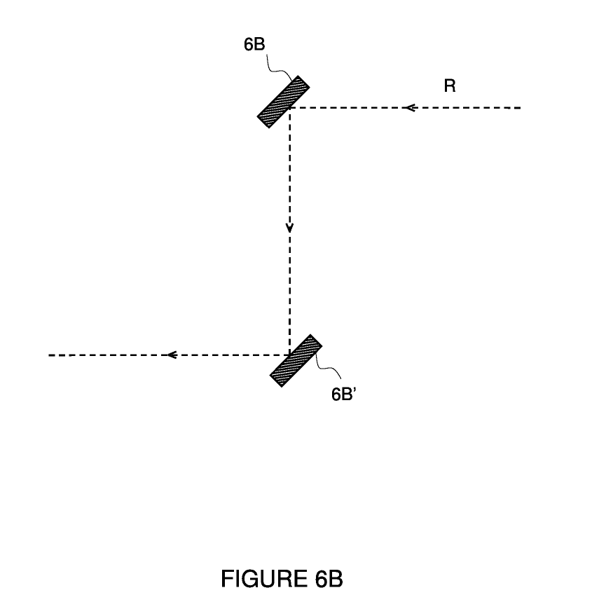

FIG. 6A illustrates an embodiment of an optical element used to redirect light rays onto iris imaging camera 104. In the illustrated embodiment, the optical element is a mirror R6A, positioned and angled such that incident ray R is redirected off the mirror surface and onto iris camera 104. In the illustrated embodiment, redirection of incident ray R causes a folding of the optical path of the incident ray.

FIG. 6B illustrates another embodiment, where a pair of folding mirrors R6B and R6B′ are positioned and angled such that incident ray R is redirected from the original path of the incident ray. In preferred embodiments, optical elements may be used to fold the optical path between any two elements of the apparatus, including between the subject's eye and the iris imaging camera—which can offer particular advantages when implementing a compact imaging apparatus, or within a device with narrow width profiles.

It would be understood that the number of optical elements and their positioning can be varied to appropriately achieve redirection of an incident ray from its original path. Further, instead of mirrors, optical elements may include prisms or any other devices capable of redirecting light rays. Yet further, the application of optical elements may be used to appropriately configure the optical path of light rays travelling between any two elements within the apparatuses disclosed herein.

It would be understood that alteration of any of the embodiments disclosed in this written description may be appropriately altered by introduction of one or more folding optical elements, without departing from the spirit of the invention. Any embodiment that is equivalent to any of the discussed embodiments when unfolded around one or more folding optical elements, is also covered by this invention.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A method for acquiring an image of a subject's iris, within the near infrared region of the electromagnetic spectrum, the method comprising the steps of:
generating from an incandescent light source, near infrared radiation having wavelengths spread across 700 nm to 900 nm;
illuminating the iris for imaging by directing the generated near infrared radiation along an optical path between the incandescent light source and an intersection of a field of view region and depth of field region of an iris camera;
receiving at the iris camera, near infrared radiation scattered by the iris and transmitted along the iris camera's optical axis; and
acquiring at the iris camera, an image of the iris based on radiation scattered by the iris and received at the iris camera.

2. The method as claimed in claim 1, wherein the iris is simultaneously illuminated by directing visible wavelengths and near infrared wavelengths generated from the incandescent light source along the optical path.

3. The method as claimed in claim 2, wherein the image acquired at the iris camera is based on simultaneously received visible wavelengths and near infrared radiation scattered by the iris and transmitted along the iris camera's optical axis.

4. The method as claimed in claim 2, wherein the incandescent light source is a single incandescent element.

5. The method as claimed in claim 1, comprising optimizing area of the iris available for image capture by directing visible light generated by the incandescent light source along the optical path and on to the iris, thereby causing the subject's pupil to constrict.

6. The method as claimed in claim 5, wherein the incandescent light source is a single incandescent element.

7. The method as claimed in claim 1, comprising providing a light shield disposed to block ambient light from being reflected off the iris.

8. The method as claimed in claim 7, wherein the step of providing the light shield comprises resiliently deforming at least a portion of the light shield against corresponding portions of the subject's facial anatomy to create a light tight seal around the subject's eye.

9. The method as claimed in claim 1, further comprising positioning a feedback object such that, the feedback object is fully visible only when the subject's iris is located within the intersection of the field of view region and the depth of field region of the iris camera.

10. The method as claimed in claim 9, wherein the incandescent light source is the feedback object.

11. The method as claimed in claim 9, wherein the incandescent light source is positioned to illuminate the iris and the feedback object.

12. The method as claimed in claim 9, further comprising providing an occluder between the incandescent light source and the intersection of the field of view region and the depth of field region, wherein the occluder prevents the subject from partially or fully viewing the feedback object from at least one position outside the intersection of the field of view region and the depth of field region.

13. The method as claimed in claim 12, wherein the occluder includes an aperture.

14. The method as claimed in claim 9, wherein the feedback object is positioned such that in viewing the feedback object, either the subject's eye is looking in a direction of the iris camera, or deviation between a direction in which the subject's eye is looking and the direction of the iris camera is between 0° and 30°.

15. The method as claimed in claim 1, wherein the incandescent light source generates near infrared wavelengths having an intensity sufficient for iris image acquisition and visible wavelengths having an intensity insufficient to cause the subject to squint.

16. The method as claimed in claim 15, wherein the intensity of visible wavelengths is chosen to a degree sufficient to allow the subject to widen its eyelid to fully observe the incandescent light source.

17. The method as claimed in claim 15, wherein the intensity of visible wavelengths is chosen to a degree sufficient to constrict the iris or the subject's eye.

18. An apparatus for acquiring an image of a subject's iris within the near infrared region of the electromagnetic spectrum, comprising:
an incandescent light source for generating near infrared radiation having wavelengths spread across 700 nm to 900 nm, and positioned to illuminate the iris with the near infrared radiation;
an iris camera configured to acquire images within the near infrared region of the electromagnetic spectrum, and positioned to receive near infrared radiation transmitted from the incandescent light source and scattered by the iris; and
a housing.

19. The apparatus as claimed in claim 18, wherein the incandescent light source additionally generates visible light and is positioned to illuminate the iris with visible light and near infrared radiation.

20. The apparatus as claimed in claim 19, wherein the iris camera is configured to acquire images based on visible light and near infrared radiation and is positioned to simultaneously receive visible light and near infrared radiation transmitted from the incandescent light source and scattered by the iris.

21. The apparatus as claimed in claim 20, wherein the incandescent light source is a single incandescent element.

22. The apparatus as claimed in claim 18, wherein the incandescent light source is a single incandescent element.

23. The apparatus as claimed in claim 18, wherein the incandescent light source is additionally positioned to optimize area of the iris available for image capture by directing visible light onto the iris, thereby causing the subject's pupil to constrict.

24. The apparatus as claimed in claim 18, wherein the housing comprises a light shield to block ambient light from causing specular reflections on the iris.

25. The apparatus as claimed in claim 24, wherein the light shield conforms to corresponding portions of facial anatomy to provide a light tight seal around the subject's eye.

26. The apparatus as claimed in claim 18, comprising a feedback object positioned such that in viewing said feedback object, the subject's iris is located within an intersection of a field of view region and a depth of field region of the iris camera.

27. The apparatus as claimed in claim 26, wherein the incandescent light source is the feedback object.

28. The apparatus as claimed in claim 26, wherein the incandescent light source is positioned to illuminate the iris and the feedback object.

29. The apparatus as claimed in claim 26, comprising an occluder disposed between the incandescent light source and the intersection of the field of view region and the depth of field region, and the occluder is structured to prevent the subject from partially or fully viewing the feedback object from at least one position outside the intersection of the field of view region and the depth of field region.

30. The apparatus as claimed in claim 29, wherein the occluder is provided with an aperture.

31. The apparatus as claimed in claim 26, wherein the feedback object is positioned such that in viewing the feedback object, either the subject's eye is looking in a direction of the iris camera, or deviation between a direction in which the subject's eye is looking and the direction of the iris camera is between 0° and 30°.

32. The apparatus as claimed in claim 18, wherein the incandescent light source generates near infrared wavelengths having an intensity sufficient for iris image acquisition and visible wavelengths having an intensity insufficient to cause the subject to squint.

33. The apparatus as claimed in claim 32, wherein the incandescent light source generates visible wavelengths having intensity of a sufficiently low degree so as to cause the subject to widen its eyelid to fully observe the intensity regulated incandescent light source.
